(19) United States
(12) Patent Application Publication
(10) Pub. No.: US 2006/0268145 A1
(43) Pub. Date: Nov. 30, 2006

(54) CMOS image sensor capable of auto focus control and camera device including the same

(75) Inventors: Jang-Sik Moon, Chungcheongbuk-do (KR); Jeong-Guk Lee, Chungcheongbuk-do (KR); Ji-Hye Moon, Chungcheongbuk-do (KR)

Correspondence Address: MORGAN LEWIS & BOCKIUS LLP, 1111 PENNSYLVANIA AVENUE NW, WASHINGTON, DC, 20004, US

(73) Assignee: MagnaChip Semiconductor, Ltd.

(21) Appl. No.: 11/496,471

(22) Filed: Aug. 1, 2006

(30) Foreign Application Priority Data
Mar. 8, 2005 (KR) 2005-0071001

(51) Int. Cl. H04N 5/225

(52) U.S. Cl. 348/340

(57) ABSTRACT

A CMOS image sensor capable of auto focus control includes a sensing unit having a plurality of unit pixels for receiving an optical image of an external subject and outputting an electrical color signal of a corresponding pixel for each unit pixel, a control unit converting the electrical color signal from the sensing unit into a digital signal, processing the digital signal to output an image signal, and controlling the sensing unit, an auto focus (AF) algorithm unit receiving the image signal and calculating a focus value using an AF tracking algorithm, and an actuator control unit controlling an actuator using the focus value.

### FIELD OF THE INVENTION

The present invention relates to an apparatus capable of auto focus control, and more particularly, to a complementary metal-oxide semiconductor (CMOS) image sensor capable of auto focus control and a camera device including the same.

### DESCRIPTION OF RELATED ARTS

An image sensor is a semiconductor device that converts an optical image into an electrical signal. In an image sensor such as a charge coupled device (CCD), metal-oxide semiconductor (MOS) capacitors are arranged such that the capacitors are very close to one another, and charge carriers are stored and transferred at the capacitors.

On the contrary, complementary metal-oxide semiconductor (CMOS) technology is applied to fabrication of a CMOS image sensor such that a control circuit and a signal processing circuit are used as a peripheral circuit, and a plurality of MOS transistors are provided as many as the unit pixels to drive the same number of the unit pixels. Therefore, the CMOS image sensor employs a switching scheme for successively detecting outputs using the peripheral circuit and the MOS transistors. Thus, the CMOS image sensor is generally used in a micro camera, having improved low power consumption and high-integration characteristics.

When incident light parallel to an optical axis of an optical system passes through a lens, or is reflected on a reflection mirror converged into or diverged from a certain point, this point becomes a focus of the lens or the reflection mirror. Therefore, a lens in the CMOS image sensor is generally required to be focused on a subject, and this particular function can be performed by an auto focus control (AFC).

Examples of the AFC include adjusting a distance of an object lens and an ocular in a telescope, and adjusting a distance between an object lens and a film in a camera. Meanwhile, a camera may focus on the subject using a compound lens to alter focusing distances. The AFC measures distances by a triangulation method and adjusts the lens accordingly.

In a recent image sensor system, the AFC function has become an essential function of an image sensor. Achieving a clearer focus in various environments has become a criterion for determining capabilities of an image sensor. Thus, more image sensor systems have equipped itself with the AFC function. It has become important to obtain the finest image by moving the lens to an optimum focus within the shortest period of time.

FIG. 1 illustrates a block diagram of a typical camera device having an AFC function. The typical camera device includes a lens module 100, a CMOS image sensor 101, and an image processor 102. The lens module 100 receives an optimum focus depending on a subject through the AFC function, and includes a lens 100A to concentrate light and an actuator 100B to drive the lens 100A. The CMOS image sensor 101 converts an optical image of the subject into an electrical signal through the lens module 100, and transforms the electrical signal into image information having a suitable format for an image outputting. The CMOS image sensor 101 uses the CMOS technology. The image processor 102 processes a signal outputted from the CMOS image sensor 101 per each frame, calculates a focus value for driving the lens module 100.

A driver 103 is shown with a perforated block in FIG. 1. The driver 103 drives the lens module 100 by receiving a focus value control signal CTRL supplied from the image processor 102. The perforated block is drawn in such a manner to imply that the driver 103 may or may not be used. In more detail, the focus value control signal CTRL is related to controlling the position of the lens. Meanwhile, the image processor 102 receives a state value STATE from the lens module 100.

In the AFC system using the typical CMOS image sensor having the above constitutions, the optimum focus is found by having a separate control chip (IC) outside the CMOS image sensor to control the CMOS image sensor, processing image information per each frame outputted from the CMOS image sensor, and generating a focus value to control the actuator according to an AFC algorithm embedded in the control chip.

In this particular method, receiving data from the image sensor, processing images, and controlling the actuator are generally essential steps. However, a certain operation time is generally required for controlling the actuator, and as a result, a period of time required for the AFC function may increase.

Furthermore, an image obtained at a stable position of the lens may not be obtained after the actuator completes the operations because controlling of the actuator and controlling of the CMOS image sensor are performed separately. In more detail, the operation timing of the actuator and the operation timing of the CMOS image sensor need to be controlled. Thus, the AFC algorithm operation may become unstable. Consequently, an improved control method for an AFC actuator is needed, wherein the AFC actuator sends and receives control signals while the CMOS image sensor processes outputted image data in real time and internally obtains images.

### SUMMARY OF THE INVENTION

It is, therefore, an object of the present invention to provide a complementary metal-oxide semiconductor (CMOS) image sensor and a camera device including the same, wherein the CMOS image sensor can reduce additional time for an auto focus control (AFC) process, and stably perform an AFC algorithm operation.

In accordance with an aspect of the present invention, there is provided a CMOS image sensor, including: a sensing unit having a plurality of unit pixels for receiving an optical image of an external subject and outputting an electrical color signal of a corresponding pixel for each unit pixel; a control unit converting the electrical color signal from the sensing unit into a digital signal, processing the digital signal to output an image signal, and controlling the sensing unit; an auto focus (AF) algorithm unit receiving the image signal and calculating a focus value using an AF tracking algorithm; and an actuator control unit controlling an actuator using the focus value.

In accordance with another aspect of the present invention, there is provided a camera device, including: a lens module including a lens that concentrates light and an actuator that drives the lens, the lens module obtaining an adequate focus for a subject through an auto focus control (AFC) function; and a CMOS image sensor employing a CMOS technology, the CMOS image sensor converting an optical image of a subject through the lens module into an electrical signal, and converting the electrical signal into image information having a suitable format for an image outputting, wherein the CMOS image sensor includes a controller that controls the actuator, processing outputs of the CMOS image sensor per each frame, and calculating a focus value for driving the lens module.

### BRIEF DESCRIPTION OF THE DRAWINGS

The above and other objects and features of the present invention will become better understood with respect to the following description of the exemplary embodiments given in conjunction with the accompanying drawings, in which:

FIG. 1 illustrates a block diagram of a typical camera device having an auto focus control (AFC) function;

FIG. 2 illustrates a block diagram of a camera device having an AFC function in accordance with a specific embodiment of the present invention;

FIG. 3 illustrates a block diagram of a complementary metal-oxide semiconductor (CMOS) image sensor shown in FIG. 2 in accordance with a specific embodiment of the present invention;

FIG. 4 illustrates a block diagram of an actuator control unit shown in FIG. 3;

FIG. 5 illustrates a block diagram of an actuator, which is open-loop controlled to operate through the actuator control unit shown in FIG. 4; and

FIG. 6 illustrates a block diagram of an actuator which is close-loop controlled to operate through the actuator control unit shown in FIG. 4.

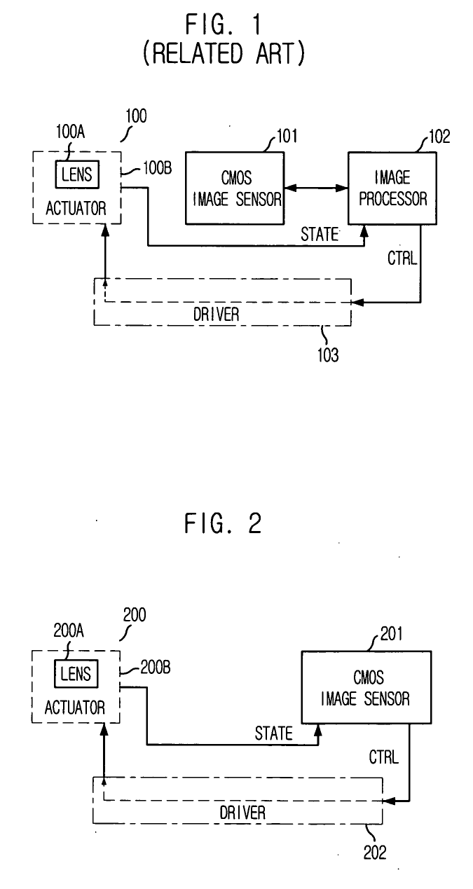

### DETAILED DESCRIPTION OF THE INVENTION

A complementary metal-oxide semiconductor (CMOS) image sensor capable of auto focus control and a camera device including the same in accordance with exemplary embodiments of the present invention will be described in detail with reference to the accompanying drawings.

FIG. 2 illustrates a block diagram of a camera device having an auto focus control (AFC) function in accordance with a specific embodiment of the present invention. The camera device includes a lens module 200 and a CMOS image sensor 201. The lens module 200 obtains an optimum focus depending on a subject through the AFC function, and includes a lens 200A to concentrate light and an actuator 200B to drive the lens 200A. The CMOS image sensor 201 converts an optical image of the subject into an electrical signal through the lens module 200, and converts the electrical signal into image information having a suitable format for an image outputting. The CMOS image sensor 201 uses the CMOS technology. The CMOS image sensor 201 includes a controller to control the actuator 200B. The CMOS image sensor 201 processes outputs of the CMOS image sensor 201 per each frame and calculates a focus value for driving the lens module 200.

A driver 202 is shown with a perforated block in FIG. 2. The driver 202 drives the lens module 200 by receiving a focus value control signal CTRL supplied from the CMOS image sensor 201. The perforated block is drawn in such a manner to imply that the driver 202 may or may not be employed. Meanwhile, the CMOS image sensor 201 receives a state value STATE from the lens module 200.

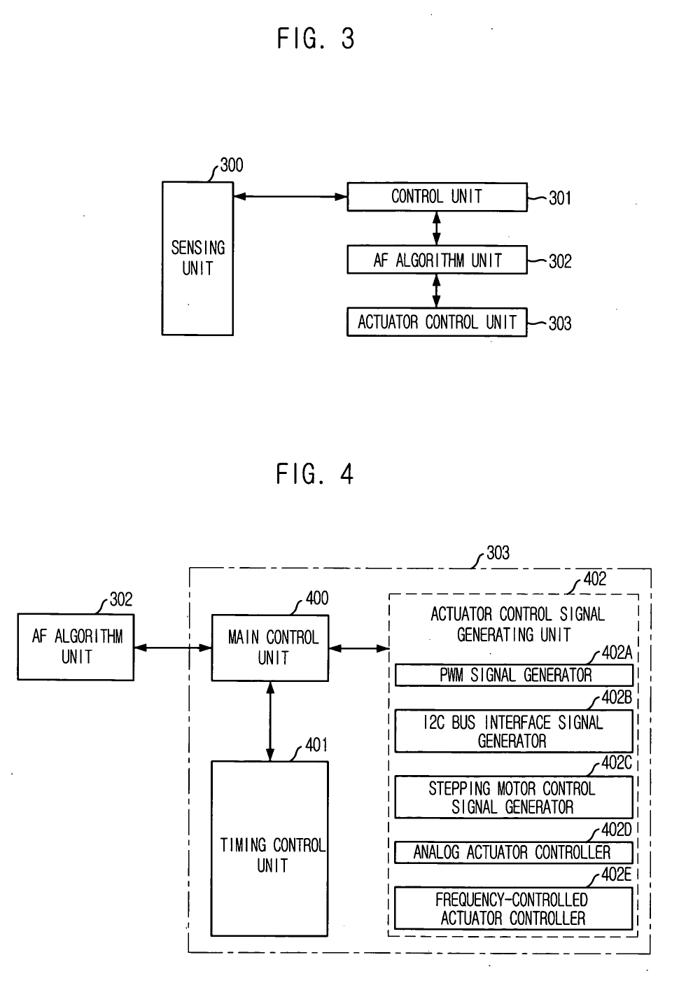

FIG. 3 illustrates a block diagram of the CMOS image sensor shown in FIG. 2 in accordance with a specific embodiment of the present invention. FIG. 3 only illustrates parts related to auto focusing from the CMOS image sensor. The CMOS image sensor includes a sensing unit 300, a control unit 301, an auto focus (AF) algorithm unit 302, and an actuator control unit 303. The sensing unit 300 includes a plurality of unit pixels. The sensing unit 300 receives optical images of external subjects through the unit pixels, and outputs an electrical color signal of a corresponding pixel for each unit pixel. The control unit 301 that controls the sensing unit 300 converts the electrical color signal outputted from the sensing unit 300 into a digital signal, and processes the digital signal to output a image signal. The AF algorithm unit 302 receives the image signal from the control unit 301 and calculates a focus value using a tracking algorithm for AFC. The actuator control unit 303 controls an actuator using the focus value. Meanwhile, the actuator includes almost all necessary driver chips (IC), circuits, and lenses used to alter a position of a focus for an image when performing auto focusing using the CMOS image sensor.

FIG. 4 illustrates a block diagram of the actuator control unit 303 shown in FIG. 3. The actuator control unit 303 includes a main control unit 400, an actuator control signal generating unit 402, and a timing control unit 401. The main control unit 400 controls overall operations of the actuator, and the actuator control signal generating unit 402 generates an actuator control signal. The timing control unit 401 secures time for the actuator control signal to be stabilized after controlling the actuator for obtaining a stable image.

The main control unit 400 converts a control signal generated from the AF algorithm unit 302 in a manner that the control signal corresponds to an input signal of the actuator control signal generating unit 402. The main control unit 400 then provides the converted control signal to the actuator control signal generating unit 402. Thus, the AF algorithm unit 302 and the actuator control signal generating unit 402 are interlocked with each other in operation.

The main control unit 400 converts the control signal outputted from the AF algorithm unit 302 in a manner that the control signal corresponds to an input signal of the timing control unit 401. The main control unit 400 provides the converted control signal to the timing control unit 401. Thus, the AF algorithm unit 302 and the timing control unit 401 are interlocked with each other in operation.

The main control unit 400 determines operation states of the timing control unit 401 and the actuator control signal generating unit 402, and informs the AF algorithm unit 302 of a completion state of the actuator control signal generation, allowing the AF algorithm unit 302 to perform the AFC function with stable images.

When pieces of information related to the actuator operation states generated at an actuator module are inputted, the main control unit 400 provides the following functions. The main control unit 400 prevents the actuator from deviating from an initialization operation or a defined range of a limited actuator operation, and allows the AF algorithm unit 302 to use a stable image by generating a signal for determining the actuator state using the actuator state information inputted externally.

The initialization operation of the actuator represents a process of controlling the actuator as the initialization state determined at the time of the actuator module fabrication. The defined range of the limited actuator operation represents limiting available final discharging voltages, positions, frequencies, duty rates of output signals, and control phase signals of the actuator.

The actuator control signal generating unit 402 includes a pulse width modulation (PWM) signal generator 402A, an inter-integrated circuit (I2C) bus interface signal generator 402B, a stepping motor control signal generator 402C, an analog actuator controller 402D, and a frequency-controlled actuator controller 402E.

The analog actuator controller 402D controls the actuator with a voltage, using an internal or external digital-to-analog (DAC) converter structure. The frequency-controlled actuator controller 402E controls the actuator using frequency fluctuation by empolying a frequency generator. The actuator control signal generating unit 402 includes one or more of the above listed devices, i.e., the PWM signal generator 402A, the I2C bus interface signal generator 402B, the stepping motor control signal generator 402C, the analog actuator controller 402D, and the frequency-controlled actuator controller 402E.

The actuator control signal generating unit 402 outputs a corresponding signal by operating a predetermined controller which is selected by receiving the control signal of the main control block 400. The actuator control signal generating unit 402 transfers a completion signal to the main control unit 400 after performing a command inputted from the main control unit 400. Thus, the actuator control signal generating unit 402 allows the main control unit 400 to determine and process actuator stabilization timing.

The timing control unit 401 performs adequate delay timing calculation and timing delay control functions to adjust time additionally needed for the actuator to be stabilized in a state indicated by an algorithm of the AF algorithm unit 302 even when outputting of the actuator control signal is completed in response to the command of the AF algorithm unit 302.

A delay timing value for adjusting timing can be calculated or selected by one of the methods listed below:

A) selecting a constant;

B) selecting every time an intended value from a timing table in a storing device inside a CMOS image sensor;

C) selecting every time an intended value from a timing table in a storing device outside a CMOS image sensor;

D) calculating a timing value by an algorithm related to positions before and after performing an actuator control command;

E) calculating a timing value by constructing an algorithm of an N^{th} equation as logics, where N is an integer;

F) calculating a timing value by simplifying a logarithmic (log, ln) algorithm as logics; and

G) performing a four fundamental arithmetic operation algorithm including one or more of the above listed methods A to F.

The timing control unit 401 controls timing using the above described selection and calculation methods. Thus, the timing control unit 401 allows the main control unit 400 to send a control signal related to an actuator stabilization state to the AF algorithm unit 302.

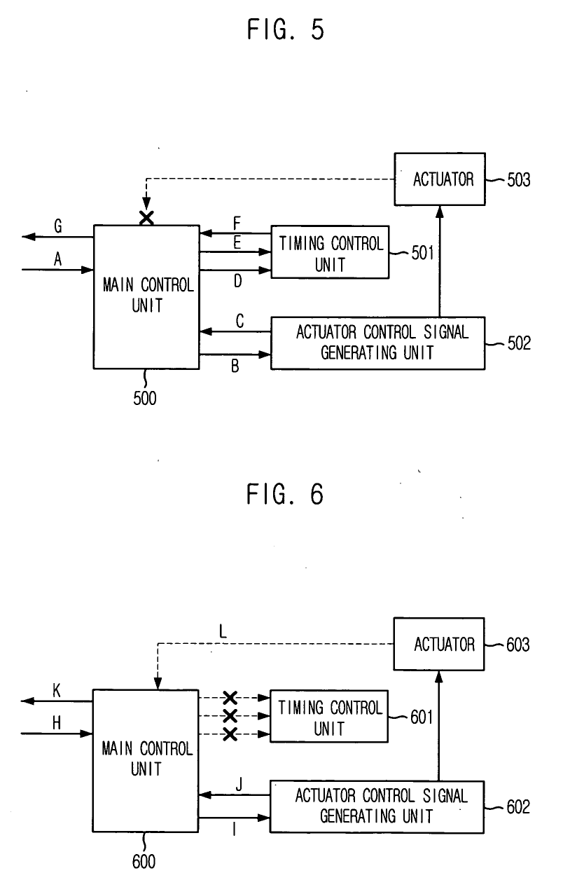

FIG. 5 illustrates a block diagram of an actuator which is open-loop controlled to operate by the actuator control unit 303 shown in FIG. 4. An actuator 503 includes an actuator and related circuits. There is no signal (i.e., a signal representing a state of the actuator) being inputted from the actuator 503 to a main control unit 500 in an open loop.

A first desired state value supplied from the AF algorithm unit 302 (refer to FIG. 4), that is, an intended focus value to be obtained by the actuator 503, is inputted into the main control unit 500. The first desired value is represented with reference letter ‘A’. The main control unit 500 converts the inputted first desired state value ‘A’ into a second desired state value ‘B’ which is an input value that can be processed in an actuator control signal generating unit 502. The second desired state value ‘B’ may be substantially the same as the first desired state value ‘A’.

The actuator control signal generating unit 502 receives the second desired state value ‘B’ and generates an actuator control signal. Then, the actuator control signal generating unit 502 supplies a first operation completion signal ‘C’ to the main control unit 500. The first operation completion signal ‘C’ informs that the last signal for transforming the actuator state into the second desired state value ‘B’ is outputted.

The main control unit 500 provides a state fluctuation quantity ‘D’, which is a difference between a new first desired state and a previous first desired state, to a timing control unit 501. The timing control unit 501 calculates a needed timing delay using the state fluctuation quantity ‘D’.

As the first operation completion signal ‘C’ is inputted, the main control unit 500 provides a signal ‘E’ for operating the timing control unit 501 to the timing control unit 501. The timing control unit 501 operates in response to the signal ‘E’. After the signal ‘E’ is inputted, the timing control unit 501 provides a signal ‘F’ to inform the main control unit 500 of the completion of a process for maintaining the timing delay.

The main control unit 500 provides a signal ‘G’ to the AF algorithm unit 302 (refer to FIG. 4). The signal ‘G’ contains information on the generations of the first operation completion signal ‘C’, and the signal ‘F’, and that an actuator control and stabilization time is secured.

FIG. 6 is a block diagram of an actuator which is close-loop controlled to operate by the actuator control unit 303 shown in FIG. 4. An actuator 603 includes an actuator and related circuits. There is a signal (i.e., a signal representing a state of the actuator) being inputted from the actuator 603 to a main control unit 600 in a closed loop.

A first desired state value supplied from the AF algorithm unit 302 (refer to FIG. 4), that is, an intended focus value to be obtained by the actuator 603, is inputted into the main control unit 600. The first desired value is represented with reference letter ‘H’. The main control unit 600 converts the inputted first desired state value ‘H’ into a second desired state value ‘I’ which is an input value that can be processed in an actuator control signal generating unit 602. The second desired state value ‘I’ may be substantially the same as the first desired state value ‘H’.

The actuator control signal generating unit 602 receives the second desired state value ‘I’ and generates an actuator control signal. Then, the actuator control signal generating unit 602 supplies a first operation completion signal ‘J’ to the main control unit 600. The first operation completion signal ‘J’ informs that the last signal for transforming the actuator state into the second desired state value ‘I’ is outputted.

The actuator 603 provides an actuator feedback state value ‘L’ to the main control unit 600 when there is an output representing a state of the actuator 603. The actuator feedback state value ‘L’ may be inputted directly through a port of an IC, and also through inputting of a register inside of the IC performed by a controller outside of the IC.

When the first operation completion signal ‘J’ is generated, the main controller 600 provides a signal ‘K’ to the AF algorithm unit 302 (refer to FIG. 4) if the actuator feedback state value ‘L’ is substantially the same as a desired state value within a predetermined standard deviation range. The signal ‘K’ informs that an actuator control and stabilization time is secured.

The CMOS image sensor consistent with this embodiment has the actuator control function which allows faster and more stabilized operations when using the AFC algorithm in a system using the CMOS image sensor. The CMOS image sensor having the actuator control function for AFC may solve deteriorating central processing unit (CPU) operation time, processing capabilities, and operation speed needed for the typical AFC processing.

Furthermore, it may become possible to obtain an AFC algorithm using a stable frame image through interlocking the actuator control, the AFC algorithm, and the CMOS image sensor control, and by applying the timing control method for stabilizing the actuator operation state. Thus, making a wrong decision with a frame image having an unstable AFC algorithm can be prevented. Consistent with this embodiment, the CMOS image sensor formed on a P-type substrate is described. However, this embodiment can be applied to other types of image sensors including charge coupled devices (CCD).

Consistent with this invention, the performance of the image sensor having an auto focus control function may be enhanced by improving the timing delay for the auto focus control and securing a stable operation.

The present application contains subject matter related to the Korean patent application No. KR 2005-0071001, filed in the Korean Patent Office on Aug. 3, 2005, the entire contents of which being incorporated herein by reference.

While the present invention has been described with respect to certain specific embodiments, it will be apparent to those skilled in the art that various changes and modifications may be made without departing from the spirit and scope of the invention as defined in the following claims.

What is claimed is:

1. A complementary metal-oxide semiconductor (CMOS) image sensor, comprising:
a sensing unit having a plurality of unit pixels for receiving an optical image of an external subject and outputting an electrical color signal of a corresponding pixel for each unit pixel;
a control unit converting the electrical color signal from the sensing unit into a digital signal, processing the digital signal to output an image signal, and controlling the sensing unit;
an auto focus (AF) algorithm unit receiving the image signal and calculating a focus value using an AF tracking algorithm; and
an actuator control unit controlling an actuator using the focus value.

2. The CMOS image sensor of claim 1, wherein the actuator control unit comprises:
a main control unit controlling the actuator and related circuits;
an actuator control signal generating unit generating an actuator control signal; and
a timing control unit controlling timing to secure time for the actuator control signal to be stabilized after the actuator is controlled.

3. The CMOS image sensor of claim 2, wherein the main control unit:
converts a control signal generated from the AF algorithm unit in a manner that the control signal corresponds to an input signal of the actuator control signal generating unit and provides the converted control signal to the actuator control signal generating unit; and
converts the control signal generated from the AF algorithm unit in a manner that the control signal corresponds to an input signal of the timing control unit and provides the converted control signal to the timing control unit.

4. The CMOS image sensor of claim 3, wherein the main control unit:
determines operation states of the timing control unit and the actuator control signal generating unit and informs the AF algorithm unit of a completion state of the actuator control signal generation;
prevents the actuator from deviating from an initialization operation or a defined range of a limited actuator operation using inputted information related to actuator operation states generated at an actuator module; and
generates a signal for determining stability of the actuator state using actuator state information inputted externally.

5. The CMOS image sensor of claim 2, wherein the actuator control signal generating unit comprises one selected from a group consisting of: a pulse width modulation (PWM) signal generator, an inter-integrated circuit (I2C) bus interface signal generator, a stepping motor control signal generator, an analog actuator controller, a frequency-controlled actuator controller, and a combination thereof.

6. The CMOS image sensor of claim 5, wherein the actuator control signal generating unit transfers a completion signal to the main control unit after performing a command inputted from the main control unit to allow the main control unit to determine and process actuator stabilization timing.

7. The CMOS image sensor of claim 2, wherein the timing control unit performs adequate delay timing calculation and timing delay control functions to adjust time additionally needed for the actuator to be stabilized in a state indicated by an algorithm of the AF algorithm unit even when outputting of the actuator control signal is completed in response to a command of the AF algorithm unit.

8. The CMOS image sensor of claim 7, wherein the timing control unit calculates a delay timing value for adjusting timing by performing a four fundamental arithmetic operation algorithm using a method selected from a group consisting of: selecting a constant; selecting every time an intended value from a timing table in a storing device inside a CMOS image sensor; selecting every time an intended value from a timing table in a storing device outside a CMOS image sensor; calculating a timing value by an algorithm related to positions before and after performing an actuator control command; calculating a timing value by constructing an algorithm of an N^{th} equation as logics, where N is an integer; calculating a timing value by simplifying a logarithmic (log, ln) algorithm as logics; and a combination thereof.

9. The CMOS image sensor of claim 2, wherein the actuator is open-loop controlled and does not provide a state of the actuator to the main control unit.

10. The CMOS image sensor of claim 2, wherein the actuator is close-loop controlled and provides a state of the actuator to the main control unit.

11. The CMOS image sensor of claim 10, wherein the actuator comprises one selected from a group consisting of driver chips (IC), circuits, and lenses, the selected one used for changing a position of a focus for an image when performing auto focusing using a CMOS image sensor.

12. A camera device, comprising:
a lens module including a lens that concentrates light and an actuator that drives the lens, the lens module obtaining an adequate focus for a subject through an auto focus control (AFC) function; and
a CMOS image sensor employing a CMOS technology, the CMOS image sensor converting an optical image of a subject through the lens module into an electrical signal, and converting the electrical signal into image information having a suitable format for an image outputting, wherein the CMOS image sensor includes a controller that controls the actuator, processing outputs of the CMOS image sensor per each frame, and calculating a focus value for driving the lens module.

13. The camera device of claim 12, further comprising a driver that receives a focus value control signal from the CMOS image sensor to drive the lens module.

14. The camera device of claim 12, wherein the actuator comprises one selected from a group consisting of driver chips (IC), circuits, and lenses, the selected one used for changing a position of a focus for an image when performing auto focusing using a CMOS image sensor.

15. The camera device of claim 12, wherein the CMOS image sensor comprises:
a sensing unit having a plurality of unit pixels for receiving an optical image of an external subject and outputting an electrical color signal of a corresponding pixel for each unit pixel;
a control unit converting the electrical color signal from the sensing unit into a digital signal, processing the digital signal to output an image signal, and controlling the sensing unit;
an AF algorithm unit receiving the image signal and calculating a focus value using an AF tracking algorithm; and
an actuator control unit controlling an actuator using the focus value.

16. The camera device of claim 15, wherein the actuator control unit comprises:
a main control unit controlling the actuator and related circuits;
an actuator control signal generating unit generating an actuator control signal; and
a timing control unit controlling timing to secure time for the actuator control signal to be stabilized after the actuator is controlled.

17. The camera device of claim 16, wherein the main control unit:
converts a control signal generated from the AF algorithm unit in a manner that the control signal corresponds to an input signal of the actuator control signal generating unit and provides the converted control signal to the actuator control signal generating unit; and
converts the control signal generated from the AF algorithm unit in a manner that the control signal corresponds to an input signal of the timing control unit and provides the converted control signal to the timing control unit.

18. The camera device of claim 17, wherein the main control unit:
determines operation states of the timing control unit and the actuator control signal generating unit and informs the AF algorithm unit of a completion state of the actuator control signal generation;
prevents the actuator from deviating from an initialization operation or a defined range of a limited actuator operation using inputted information related to actuator operation states generated at an actuator module; and
generates a signal for determining stability of the actuator state using actuator state information inputted externally.

19. The camera device of claim 16, wherein the actuator control signal generating unit comprises one selected from a group consisting of: a pulse width modulation (PWM) signal generator, an inter-integrated circuit (I2C) bus interface signal generator, a stepping motor control signal generator, an analog actuator controller, a frequency-controlled actuator controller, and a combination thereof.

20. The camera device of claim 19, wherein the actuator control signal generating unit transfers a completion signal to the main control unit after performing a command inputted from the main control unit to allow the main control unit to determine and process actuator stabilization timing.

21. The camera device of claim 16, wherein the timing control unit performs adequate delay timing calculation and timing delay control functions to adjust time additionally needed for the actuator to be stabilized in a state indicated by an algorithm of the AF algorithm unit even when outputting of the actuator control signal is completed in response to a command of the AF algorithm unit.

22. The camera device of claim 21, wherein the timing control unit calculates a delay timing value for adjusting timing by performing a four fundamental arithmetic operation algorithm using a method selected from a group consisting of: selecting a constant; selecting every time an intended value from a timing table in a storing device inside a CMOS image sensor; selecting every time an intended value from a timing table in a storing device outside a CMOS image sensor; calculating a timing value by an algorithm related to positions before and after performing an actuator control command; calculating a timing value by constructing an algorithm of an N^{th} equation as logics, where N is an integer; calculating a timing value by simplifying a logarithmic (log, ln) algorithm as logics; and a combination thereof.

23. The camera device of claim 16, wherein the actuator is open-loop controlled and does not provide a state of the actuator to the main control unit.

24. The camera device of claim 16, wherein the actuator is close-loop controlled and provides a state of the actuator to the main control unit.
